(19) United States
(12) Patent Application Publication
(10) Pub. No.: US 2012/0215382 A1
(43) Pub. Date: Aug. 23, 2012

(54) SYSTEM AND METHOD FOR CONTROLLING UNMANNED AERIAL VEHICLE IN FLIGHT SPACE

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/283,602

(22) Filed: Oct. 28, 2011

(30) Foreign Application Priority Data
Feb. 23, 2011 (TW) 100105993

(51) Int. Cl. G05D 1/10

(52) U.S. Cl. 701/2

(57) ABSTRACT

In a method for controlling an unmanned aerial vehicle (UAV) in a flight space using a computing device, at least one camera is installed in the flight space. The method sets a flight area of the UAV in the flight space, and stores geographic information of the flight area into a storage device. The method further controls each of the camera to capture a series of 3D images from the flight space, analyzes a current location of the UAV in the flight space according to the 3D images, and compares the current location with the geographic information of the flight area to determine whether the UAV flies out of the flight area. In addition, the method sends a warning message to a remote controller when the UAV flies out of the flight area, and controls the UAV to fly within the flight area using the remote controller.

### BACKGROUND

1. Technical Field

The embodiments of the present disclosure relate to aircraft control systems and methods, and more particularly to a system and method for controlling an unmanned aerial vehicle (UAV) in a flight space.

2. Description of Related Art

Unmanned aerial vehicle (UAV), also known as a Unmanned aircraft System (UAS) or a remotely piloted aircraft (RPA) or unmanned aircraft, is a machine which functions either by a remote control of a navigator or pilot or autonomously, that is, as a self-directing entity. UAVs can fly autonomously or be piloted remotely without carrying a human operator, and are often preferred for missions that are too dull or dangerous for manned aircraft. Some UAVs are controlled to fly autonomously based on a pre-programmed flight plan using a dynamic automation system. However, the dynamic automation system may be more complex, and also cannot effectively control the UAV to fly within a flight space. Therefore, there is a need for a system and method for effectively controlling an UAV to safely fly within the flight space.

### BRIEF DESCRIPTION OF THE DRAWINGS

FIG. 1 is a block diagram of one embodiment of a computing device including an unmanned aerial vehicle (UAV) control system.

FIG. 2 is a flowchart of one embodiment of a method for controlling the UAV using the computing device of FIG. 1.

FIG. 3 is schematic diagram illustrating one example of a flight area in a flight space for the UAV.

FIG. 4 is schematic diagram illustrating one example of a plurality of flight areas in a flight space for the UAV.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

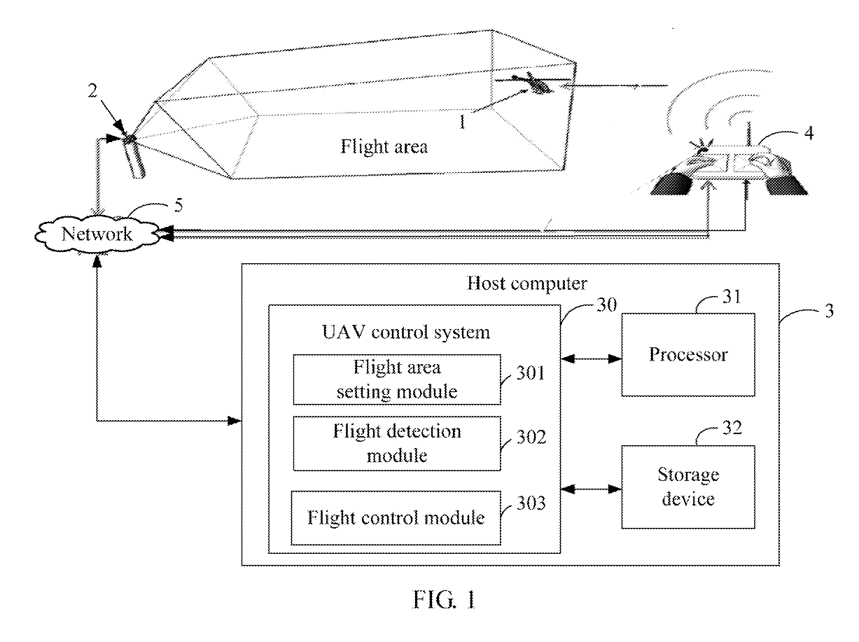

FIG. 1 is a block diagram of one embodiment of a computing device 3 including an unmanned aerial vehicle (UAV) control system 30. In the embodiment, the computing device 3 may further include at least one processor 31 and a storage device 32. The computing device 3 may be a host computer, a workstation computer, or a server computer. It should be understood that FIG. 1 illustrates only one example of the computing device 3 that may include more or fewer components than illustrated, or a different configuration of the various components in other embodiments.

The computing device 3 connects to at least one camera 2 through a network 5, such as an Ethernet network, or any other suitable local area network (LAN). In the embodiment, the camera 2 is a time of flight (TOF) camera device having a 3D image capturing functionality, and is installed in a predefined flight area. The TOF camera 2 captures a series of 3D images from the flight area when an UAV 1 flies in the flight area, and sends each of the 3D images to the computing device 3 through the network 5. The UAV 1 can be controlled to fly in the flight area by a remote controller 4 that can communicates with the computing device 3 through the network 5.

In one embodiment, the UAV control system 30 may include computerized instructions in the form of one or more programs that are executed by the at least one processor 31 and stored in the storage device 32. In one embodiment, the storage device 32 may be an internal storage system, such as a random access memory (RAM) for the temporary storage of information, and/or a read only memory (ROM) for the permanent storage of information. In some embodiments, the storage device 32 may also be an external storage system, such as an external hard disk, a storage card, or a data storage medium.

In the embodiment, the UAV control system 30 includes a flight area setting module 301, a flight detection module 302, and a flight control module 303. The modules 301-303 may comprise computerized code in the form of one or more programs that are stored in the storage device 32 and executed by the processor 31 to provide functions for implementing the modules. In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

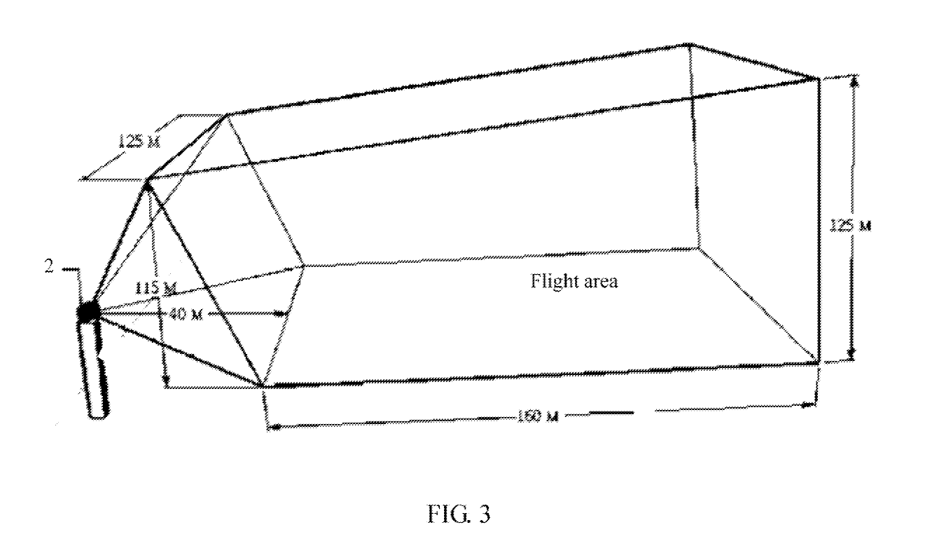

The flight area setting module 301 is operable to initialize at least one TOF camera 2 that is installed in a predefined flight space, and allocate an IP address for each of the at least one TOF camera 2. In one example with respect to FIG. 3, one TOF camera 2 is installed in the flight space, and the IP address of the TOF camera 2 may be denoted as “192.168.20.28” that can identify the location of the TOF camera 2.

The flight area setting module 301 is further operable to set a flight area for the UAV 1 in the flight space according to a view range of the TOF camera 2, and store geographic information of the flight area into the storage device 32. The TOF camera 2 has the optical range that can capture a 3D image of the flight area. Referring to FIG. 3, if the TOF camera 2 has a view range as follows: the length is 125 meters, the width is 125 meters and the height is 160+40=200 meters. The TOF camera 2 monitors the flight area having a length of 125 meters, a width of 125 meters and a height of 200 meters by capturing the 3D image of the flight area.

The flight detection module 302 is operable to create a communication connection between the TOF camera 2 and the computing device 3 according to the IP address of the TOF camera 2. The flight detection module 302 is further operable to control the TOF camera 2 to capture a series of 3D images from the flight space when the UAV 1 flies within the flight space, and receive the 3D images captured by the TOF camera 2 through the network 5. The flight detection module 302 analyzes a current location of the UAV 1 in the flight space according to the 3D images. In one embodiment, the current location may be represented by an X coordinate value, a Y coordinate value, and a Z coordinate value that indicate a geographic position of the UAV 1 in the fight space. For example, the current location may be denoted as the geographic position having coordinates (125, 125, 200) in the fight space.

The flight detection module 302 is further operable to compare the current location with the geographic information of the flight area, and determine whether the UAV 1 flies out of the flight area according to the comparison result. In one embodiment, if the current location is within the flight area, the flight detection module 302 determines that the UAV 1 does not fly out of the flight area. If the current location is not within the flight area, the flight detection module 302 determines that the UAV 1 flies out of the flight area.

The flight control module 303 is operable to generate a warning message when the UAV 1 flies out of the flight area, and send the warning message to the remote controller 4 through the network 5. In the embodiment, the UAV 1 may fly within the flight area continuously when the UAV 1 does not fly out of the flight area. The flight control module 303 is further operable to control the UAV 1 to change a flying direction of the UAV 1 using the remote controller 4 according to the warning message. In some embodiments, the flight control module 303 may control the UAV 1 to stop within the flight area according to the warning message, so that the UAV 1 can safely fly in the flight area all times.

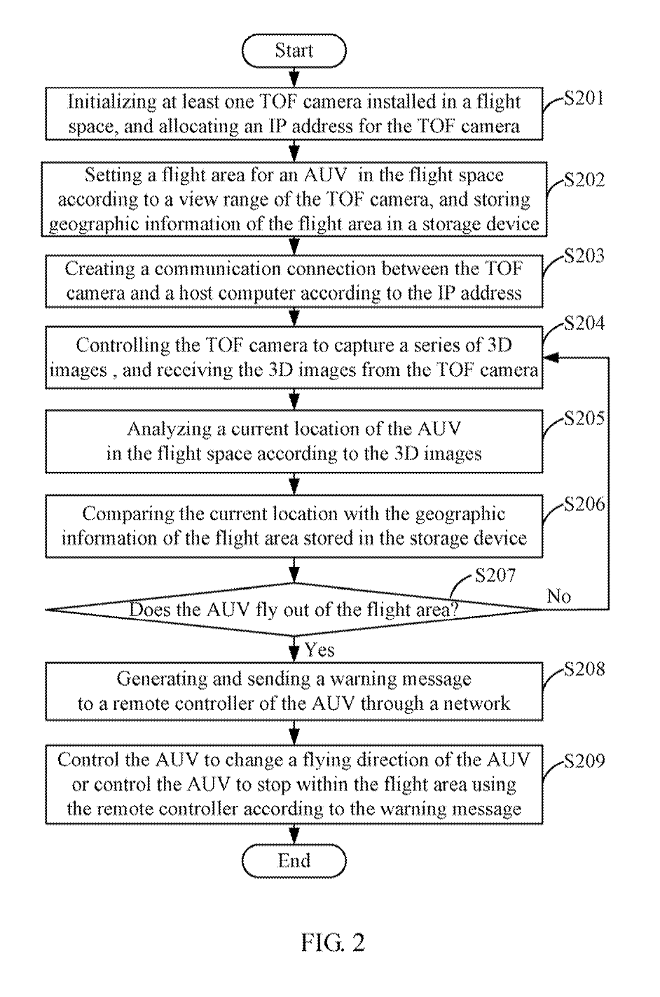

FIG. 2 is a flowchart of one embodiment of a method for controlling the UAV 1 using the computing device 3 of FIG. 1. Depending on the embodiment, additional blocks may be added, others removed, and the ordering of the blocks may be changed.

In block S201, the flight area setting module 301 initializes at least one TOF camera 2 that is in a predefined flight space, and allocates an IP address for each of the TOF camera 2. In one example with respect to FIG. 3, one TOF camera 2 is installed in the flight space, and the IP address of the TOF camera 2 may be denoted as “192.168.20.28” that can identify the location of the TOF camera 2 in the flight space.

In block S202, the flight area setting module 301 sets a flight area for the UAV 1 in the flight space according to a view range of the TOF camera 2, and stores geographic information of the flight area into the storage device 32. In one embodiment, the geographic information of the flight area includes a maximum length, a maximum width, and a maximum height of the flight area. The TOF camera 2 has the optical range that can capture a 3D image of the flight area. Referring to FIG. 3, if the TOF camera 2 has a view range as follows: the length is 125 meters, the width is 125 meters and the height is 160+40=200 meters. That is, the TOF camera 2 can monitor the flight area having a length of 125 meters, a width of 125 meters and a height of 200 meters by capturing the 3D image of the flight area.

In block S203, the flight detection module 302 creates a communication connection between the TOF camera 2 and the computing device 3 according to the IP address of the TOF camera 2. After the communication connection is created, the TOF camera 2 can communicate with the computing device 3 through the network 5.

In block S204, the flight detection module 302 controls the TOF camera 2 to capture a series of 3D images from the flight space when the UAV 1 flies within the flight space, and receives the 3D images captured by the TOF camera 2 through the network 5.

In block S205, the flight detection module 302 analyzes a current location of the UAV 1 in the flight space according to the 3D images. In one embodiment, the current location may be represented by an X coordinate value, a Y coordinate value, and a Z coordinate value that indicate a geographic position of the UAV 1 in the fight space. For example, the current location may be denoted as the geographic position having coordinates (125, 125, 200) in the fight space.

In block S206, the flight detection module 302 compares the current location with the geographic information of the flight area stored in the storage device 32. In the embodiment, the flight detection module 302 compares the X coordinate value of the current location with the maximum length of the flight area, compares the Y coordinate value of the current location with the maximum width of the flight area, and compares the Z coordinate value of the current location with the maximum height of the flight area.

In block S207, the flight detection module 302 determines whether the UAV 1 flies out of the flight area according to the comparison result. In one embodiment, if the current location is within the flight area, the flight detection module 302 determines that the UAV 1 does not fly out of the flight area. If the current location is not within the flight area, the flight detection module 302 determines that the UAV 1 flies out of the flight area. If the UAV 1 does not fly out of the flight area, block S204 is repeated. Otherwise, if the UAV 1 flies out of the flight area, block S208 is implemented.

In block S208, the flight control module 303 generates a warning message when the UAV 1 flies out of the flight area, and sends the warning message to the remote controller 4 through the network 5. In the embodiment, the UAV 1 may fly in the flight area continuously when the UAV 1 does not fly out of the flight area.

In block S209, the flight control module 303 controls the UAV 1 to change the flying direction of the UAV 1 using the remote controller 4 according to the warning message. In some embodiments, the flight control module 303 may control the UAV 1 to stop within the flight area according to the warning message, so that the UAV 1 may safely fly within the flight area all times.

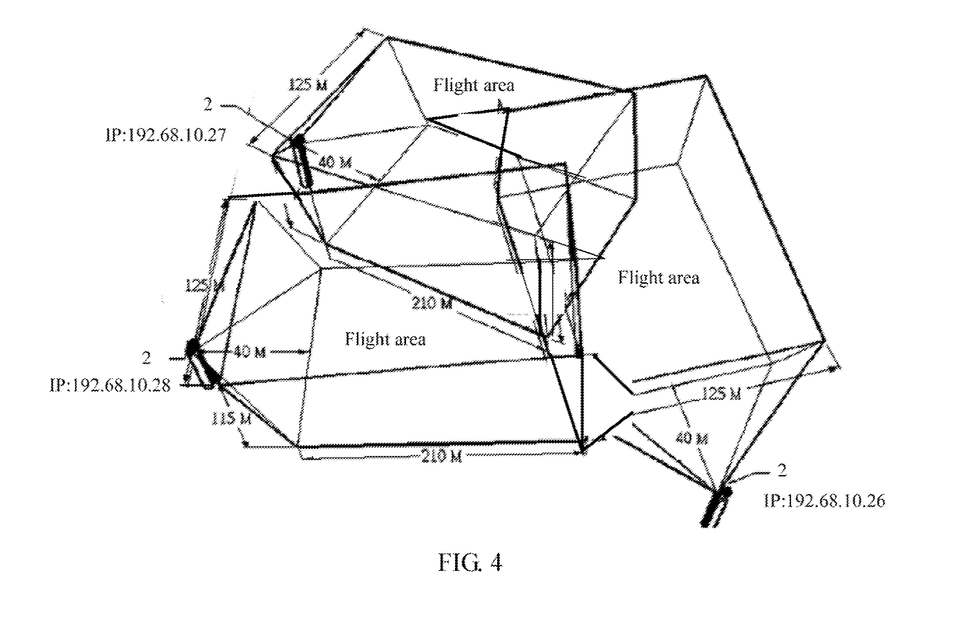

In one embodiment, only one UAV 1 is controlled to fly in the flight space by the computing device 3. In some embodiments, more than one UAVs 1 can be controlled to fly in the flight space by using the computing device 3. In one example, the flight space can be divided into one or more flight areas, and each of the flight areas may be installed with one or more TOF cameras 2. Referring to FIG. 4, the flight space is divided into three flight areas, and each of the flight areas may installed with one TOF camera 2. Each of the TOF cameras 2 can be allocated with an unique IP address, such as IP: 192.68.10.26, IP: 192.68.10.27, and IP: 192.68.10.28. Each of the TOF cameras 2 may send the 3D images to the computing device 3 according to the respective IP address of the TOF cameras 2, so that the one or more UAVs 1 can be controlled to safely fly in the flight space by the computing device 3.

All of the processes described above may be embodied in, and fully automated via, functional code modules executed by one or more general purpose processors of the computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage device;
at least one processor; and
one or more programs stored in a storage device comprising one or more programs and executable by at least one processor, the one or more programs comprising:
a flight area setting module operable to initialize at least one camera that is installed in a predefined flight space, set a flight area for an unmanned aerial vehicle (UAV) in the flight space according to a view range of each of the at least one camera, and store geographic information of the flight area into the storage device;
a flight detection module operable to control the at least one camera to capture a series of 3D images from the flight space, analyze a current location of the UAV in the flight space according to the 3D images, and compare the current location with the geographic information of the flight area to determine whether the UAV flies out of the flight area; and
a flight control module operable to generate a warning message when the UAV flies out of the flight area, send the warning message to a remote controller that is connected to the computing device, and control the UAV to fly within the flight area using the remote controller according to the warning message.

2. The computing device according to claim 1, wherein the remote controller controls the UAV to change a flying direction of the UAV in the flight area according to the warning message.

3. The computing device according to claim 1, wherein the remote controller controls the UAV to stop within the flight area according to the warning message.

4. The computing device according to claim 1, wherein the flight area setting module is further operable to allocate an Internet protocol (IP) address for each of the at least one camera.

5. The computing device according to claim 4, wherein the flight detection module is further operable to create a communication connection between each of the at least one camera and the computing device according to the IP address of the camera.

6. The computing device according to claim 1, wherein the at least one camera is a time of flight (TOF) camera device having a 3D image capturing functionality.

7. A method for controlling an unmanned aerial vehicle (UAV) in a flight space using a computing device, the method comprising:
initializing at least one camera that is installed in the flight space;
setting a flight area for the UAV in the flight space according to a view range of each of the at least one camera, and storing geographic information of the flight area into a storage device of the computing device;
controlling the at least one camera to capture a series of 3D images from the flight space when the UAV flies in the flight space;
analyzing a current location of the UAV in the flight space according to the 3D images;
comparing the current location with the geographic information of the flight area to determine whether the UAV flies out of the flight area;
generating a warning message when the UAV flies out of the flight area, and sending the warning message to a remote controller that is connected to the computing device; and
controlling the UAV to fly within the flight area using the remote controller according to the warning message.

8. The method according to claim 7, wherein the remote controller controls the UAV to change a flying direction of the UAV in the flight area according to the warning message.

9. The method according to claim 7, wherein the remote controller controls the UAV to stop within the flight area according to the warning message.

10. The method according to claim 7, further comprising:
allocating an Internet protocol (IP) address for each of the at least one camera; and
creating a communication connection between each of the at least one camera and the computing device according to the IP address of the camera.

11. The method according to claim 7, wherein the at least one camera is a time of flight (TOF) camera device having a 3D image capturing functionality.

12. The method according to claim 7, wherein the current location of the UAV is represented by an X coordinate value, a Y coordinate value and a Z coordinate value that indicate a geographic position of the UAV in the fight space.

13. A non-transitory computer-readable medium having stored thereon instructions that, when executed by at least one processor of a computing device, cause the computing device to perform a method controlling an unmanned aerial vehicle (UAV) in flight space, the method comprising:
initializing at least one camera that is installed in the flight space;
setting a flight area for the UAV in the flight space according to a view range of each of the at least one camera, and storing geographic information of the flight area into a storage device of the computing device;
controlling the at least one camera to capture a series of 3D images from the flight space when the UAV flies in the flight space;
analyzing a current location of the UAV in the flight space according to the 3D images;
comparing the current location with the geographic information of the flight area to determine whether the UAV flies out of the flight area;
generating a warning message when the UAV flies out of the flight area, and sending the warning message to a remote controller that is connected to the computing device; and
controlling the UAV to fly within the flight area using the remote controller according to the warning message.

14. The medium according to claim 13, wherein the remote controller controls the UAV to change a flying direction of the UAV in the flight area according to the warning message.

15. The medium according to claim 13, wherein the remote controller controls the UAV to stop within the flight area according to the warning message.

16. The medium according to claim 13, wherein the method further comprises:
allocating an Internet protocol (IP) address for each of the at least one camera; and
creating a communication connection between each of the at least one camera and the computing device according to the IP address of the camera.

17. The medium according to claim 13, wherein the at least one camera is a time of flight (TOF) camera device having a 3D image capturing functionality.

18. The medium according to claim 13, wherein the current location of the UAV is represented by an X coordinate value, a Y coordinate value and a Z coordinate value that indicate a geographic position of the UAV in the fight space.

19. The medium according to claim 13, wherein the medium is selected from the group consisting of a hard disk drive, a compact disc, a digital video disc, and a tape drive.
